(19) United States
(12) Patent Application Publication
(10) Pub. No.: US 2018/0089860 A1
(43) Pub. Date: Mar. 29, 2018

(54) COMPONENT MANAGEMENT SUPPORT SYSTEM AND METHOD FOR SUPPORTING COMPONENT MANAGEMENT

(71) Applicant: Panasonic Intellectual Property Management Co., Ltd., Osaka, JP (US)

(72) Inventors: NAOFUMI IKUTA, Osaka (JP); TAKUYA YAMAZAKI, Fukuoka (JP); HIROKI SAGARA, Fukuoka (JP); ISATO IWATA, Fukuoka (JP)

(21) Appl. No.: 15/705,788

(22) Filed: Sep. 15, 2017

(30) Foreign Application Priority Data
Sep. 28, 2016 (JP) 2016-189074

(51) Int. Cl. G06T 11/00; G06T 7/73; G06K 9/00

(52) U.S. Cl. CPC G06T 11/00; G06T 7/73; G06K 9/00671; H04N 5/232; G06T 2207/30164; G06T 2207/20212; G06K 9/00577

(57) ABSTRACT

There is provided a component management support system which supports put-in and out of a component to and from a component storage place, the system including a imaging unit that images information; a support information display processor that generates a superimposed composite image by superimposing the support information for supporting the put-in and out of the component to and from the component storage place on an image obtained by imaging the component storage place or a field of view of the worker; and a display that displays the superimposed composite image.

### BACKGROUND

### 1. Technical Field

The present disclosure relates to a component management support system and a method for supporting component management, which support a component to be put-in and out of a component storage place.

### 2. Description of the Related Art

In general, in a component mounting line for producing a mounting board where a component is mounted on a board, a component that is not used for current production is stored in a component storage place in a state where a carrier tape storing a component is wound and stored around a reel. A worker removes a reel storing a newly delivered component or a reel storing a remaining component not used for the current production from a tape feeder and stores them in the component storage place. When changing the mounting board to be produced, the worker picks up a reel storing a necessary component from the component storage place and mounts the reel on a tape feeder provided in a component mounter.

Various proposals have been made for supporting a worker by displaying various types of auxiliary information on a display screen provided in a component mounter or the like for the purpose of improving efficiency of such replacement management of the components (for example, see Japanese Patent Unexamined Publication No. 2006-237566). In Japanese Patent Unexamined Publication No. 2006-237566, a replacement order of components (members) for shortening a downtime of each facility such as a component mounter constituting the component mounting line is determined and is displayed on a display screen of a management computer as information for supporting the worker.

### SUMMARY

According to the disclosure, there is provided a component management support system which supports put-in and out of a component to and from a component storage place, the system including an imaging unit that images information; a support information display processor that generates a superimposed composite image by superimposing support information for supporting the put-in and out of the component to and from the component storage place on an image obtained by imaging the component storage place or a field of view of the worker; and a display that displays the superimposed composite image.

According to the disclosure, there is provided a method for supporting component management for supporting put-in and out of a component to and from a component storage place, the method including preparing support information for supporting the put-in and out of the component to and from the component storage place; and generating a superimposed composite image by superimposing the support information on an image obtained by imaging the component storage place or a field of view of the worker, and displaying the superimposed composite image on a display.

According to the disclosure, a worker can intuitively grasp a position to and from which the component is put in and out.

### BRIEF DESCRIPTION OF DRAWINGS

FIG. 1 is an explanatory view of a configuration of a component mounting system of an embodiment of the disclosure;

FIG. 2 is an explanatory view of a component mounter of an embodiment of the disclosure;

FIG. 3 is a front view of a component storage place installed in the component mounting system of an embodiment of the disclosure;

FIG. 4 is a block diagram illustrating a configuration of a control system of the component mounting system of an embodiment of the disclosure;

FIG. 5 is an explanatory view of component information for component put-in and out work in the component mounting system of an embodiment of the disclosure;

FIG. 6A is a view illustrating an example of an image outside an information terminal displayed on the information terminal in the component put-in and out work in the component mounting system of an embodiment of the disclosure;

FIG. 6B is a view illustrating an example of support information displayed on the information terminal in the component put-in and out work in the component mounting system of an embodiment of the disclosure;

FIG. 6C is a view illustrating an example of an image reflected on a field of view of a worker displayed on the information terminal in the component put-in and out work in the component mounting system of an embodiment of the disclosure;

FIG. 7A is a view illustrating an example of an image reflected on the field of view of the worker displayed on the information terminal in the component put-in and out work in the component mounting system of an embodiment of the disclosure;

FIG. 7B is a view illustrating an example of an image reflected on the field of view of the worker displayed on the information terminal in the component put-in and out work in the component mounting system of an embodiment of the disclosure;

FIG. 8A is a view illustrating an example of the support information displayed on the information terminal when a barcode is collated in the component mounting system of an embodiment of the disclosure;

FIG. 8B is a view illustrating an example of an image reflected on the field of view of the worker displayed on the information terminal when the barcode is collated in the component mounting system of an embodiment of the disclosure;

FIG. 9 is a flow diagram of a method for supporting component management of a pick-up operation in the component mounting system of an embodiment of the disclosure;

FIG. 10 is a flow diagram of a method for supporting component management of a storing operation in the component mounting system of an embodiment of the disclosure; and

FIG. 11 is an explanatory view of a second example of an information terminal used in a component mounting system of an embodiment of the disclosure.

### DETAILED DESCRIPTION

Prior to the describing of an embodiment, problems in the related art will be briefly described.

In the related art including Japanese Patent Unexamined Publication No. 2006-237566, since it is necessary for a worker to find out a stored component or store a designated component in a component storage place after reading and understanding work instruction information displayed on a display screen of a management computer, there is a problem that further improvement is necessary for the worker to intuitively grasp the work.

An object of the disclosure is to provide a component management support system and a method for supporting component management in which a position at which a worker puts in and out a component can be intuitively grasped.

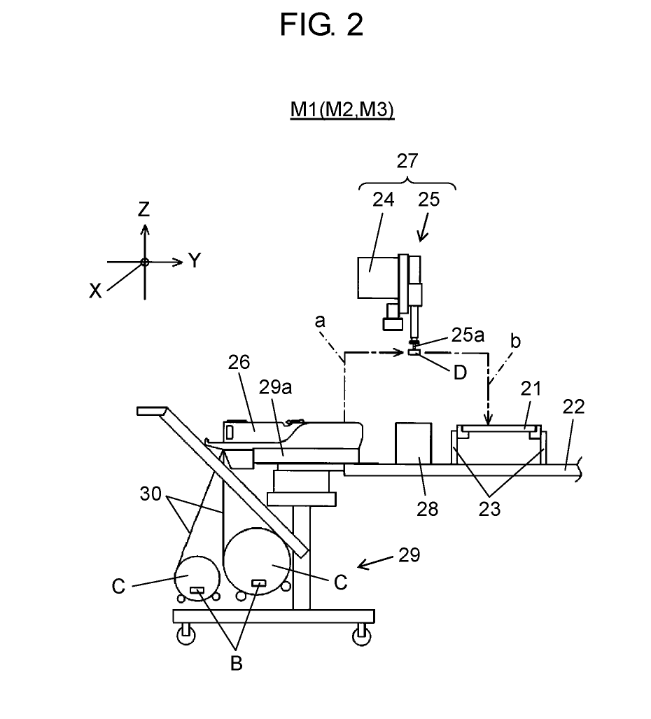

Hereinafter, an embodiment of the disclosure will be described in detail with reference to the drawings. Configurations, shapes, and the like described below are examples for explanation, and can be appropriately changed in accordance with the specification of the component mounting system (component management support system). In the following description, the same reference numerals are given to corresponding elements in all drawings and redundant explanations will be omitted. In FIG. 2 and in a part to be described later, as two axial directions orthogonal to each other in a horizontal plane, an X direction (direction perpendicular to a paper surface in FIG. 2) indicates a board transport direction and a Y direction (rightward and leftward direction on a paper surface in FIG. 2) indicates a direction orthogonal to the board transport direction. In FIG. 2 and in a part to be described later, a Z direction (upward and downward direction in FIG. 2) indicates a height direction orthogonal to the horizontal plane. The Z direction is the upward and downward direction or the orthogonal direction in a case where a component mounter is provided on the horizontal plane.

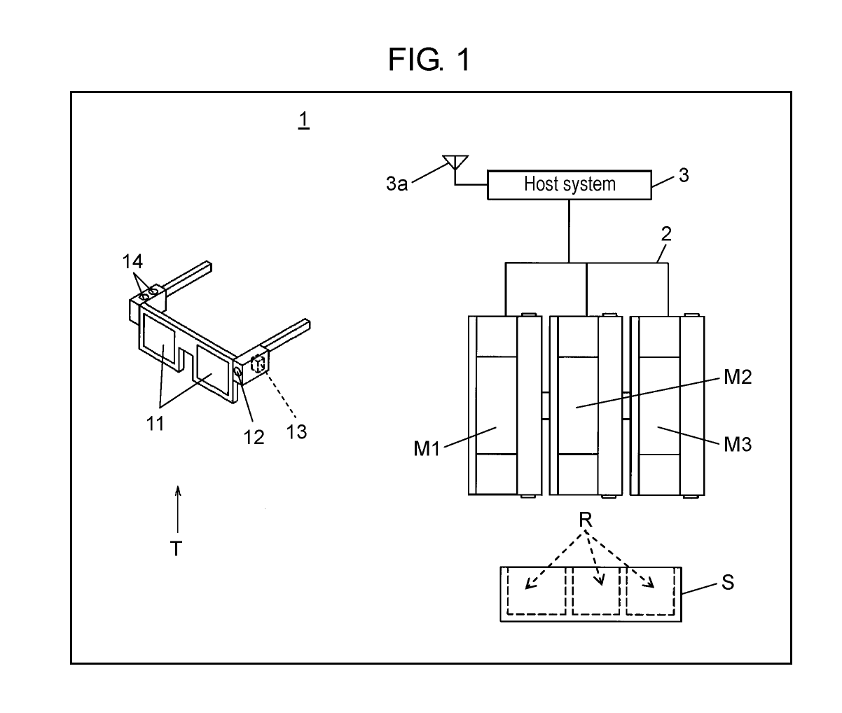

First, a configuration of component mounting system 1 will be described with reference to FIG. 1. Component mounting system 1 has a function of manufacturing a mounting board by mounting a component on a board. Component mounting system 1 has a configuration in which a plurality of component mounters M1 to M3 are connected to each other by communication network 2 and the whole is controlled by host system 3. Component mounting system 1 includes information terminal T performing wireless communication with host system 3. Host system 3 includes host-side communicator 3a performing wireless communication with information terminal T.

Component mounters M1 to M3 mount the components on the boards on which solder for component joining is printed by a solder printing apparatus (not illustrated). Component mounters M1 to M3 have board transport mechanisms for transporting the boards and the board transport mechanisms are connected in series to form a board transport path. Component mounters M1 to M3 sequentially transport the boards along the board transport path and execute component mounting work.

Information terminal T is an eyeglass type wearable terminal, a head mounted display, or the like, and includes display 11, camera 12, terminal-side communicator 13, and input unit 14. Display 11 includes a half mirror and a projection device. In a state of wearing information terminal T, a worker can simultaneously see a status outside information terminal T passed through the half mirror and various types of information projected onto the half mirror by the projection device.

That is, display 11 displays various types of information in a field of view of the worker to be superimposed. Display 11 may be any display capable of displaying various types of information to be superimposed in the field of view of the worker and may, for example, directly project various types of information onto the eyeball of the worker. Display 11 may be mounted only on one eye of the worker.

Camera 12 is an imaging unit which captures a moving image or a still image. A lens of camera 12 is provided to image a direction of the field of view of the worker wearing information terminal T. Therefore, camera 12 images a direction facing a face of the worker wearing information terminal T. Terminal-side communicator 13 performs wireless communication with host system 3. Input unit 14 is an input device such as a button, a touch sensor, or a vibration sensor, and is used for inputting instructions by the worker. Input unit 14 may be any device capable of inputting instructions from the worker, for example, may be even a voice input device via a microphone (not illustrated), or may be a motion input device by a movement of the hand of the worker imaged by camera 12, or the like.

On a floor on which component mounting system 1 is installed, component storage place S, which has a plurality of shelves R for storing a plurality of reels accommodating a carrier tape in which the components mounted on the boards in component mounters M1 to M3 are stored in a wound state, is provided. A plurality of component storage places S may also be provided in the same floor. Component storage place S may also be provided on a floor different from the floor on which component mounters M1 to M3 are provided.

Next, a configuration of component mounters M1 to M3 will be described with reference to FIG. 2. Component mounters M1 to M3 have the same configuration and, hereinafter, component mounter M1 will be described. Component mounter M1 is a device which mounts component D on board 21.

Board transport mechanism 23 provided on an upper surface of base 22 transports board 21 in the X direction to be positioned. Head moving mechanism 24 moves mounting head 25. In mounting head 25, component D supplied by tape feeder 26 attached to a side of board transport mechanism 23 is picked up by suction nozzle 25a (arrow a) and is mounted on board 21 (arrow b).

That is, head moving mechanism 24 and mounting head 25 constitute component mounting mechanism 27 which picks up component D from tape feeder 26 and mounts component D on board 21. Component D is imaged by component recognition camera 28 disposed between board transport mechanism 23 and tape feeder 26 before being mounted on board 21, and a posture of component D during mounting is corrected based on an obtained image recognition result.

Tape feeder 26 is attached to feeder base 29a provided at an upper portion of carriage 29 which freely moves on the floor and coupled to base 22. In carriage 29, reel C, in which carrier tape 30 supplying stored component D to component mounter M1 is wound and stored, is replaceably held. Bar code B including information corresponding to component D stored in carrier tape 30 in which component D is wound and stored is attached to a side surface of each of reels C. Component D stored in carrier tape 30 is specified based on information recorded in bar code B. That is, bar code B is attached to reel C which stores component D and is an identification mark for specifying component D. The identification mark is not limited to bar code B and may be a two-dimensional code.

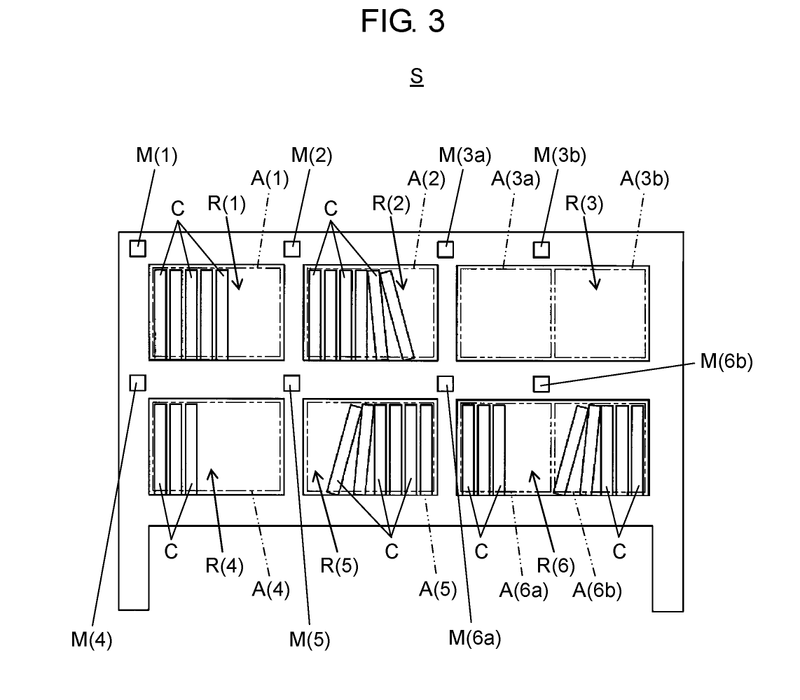

Next, component storage place S in which the plurality of shelves R storing the plurality of reels C are provided and reel C is put in and out to and from shelf R by a worker will be described with reference to FIG. 3. In an example of component storage place S illustrated in FIG. 3, three shelf R(1), shelf R(2), and shelf R(3) are disposed in an upper row and three shelf R(4), shelf R(5), and shelf R(6) are disposed in an lower row. Component arrangement section A, to and from which reel C is put in and out, is set in each shelf R. That is, component arrangement sections A(1), A(2), A(4), and A(5) are respectively set in shelves R(1), R(2), R(4), and R(5). Two component arrangement sections A(3a) and A(3b), and component arrangement sections A(6a) and A(6b) are respectively set in large shelves R(3) and R(6).

Identification mark M on which a unique shape for specifying component arrangement section A is printed is attached to a position where component storage place S can be visually recognized by seeing it from a front in a gap of shelf R. In the example of FIG. 3, identification marks M(1), M(2), M(3a), M(3b), M(4), M(5), M(6a), and M(6b) are respectively attached to upper left positions of component arrangement sections A(1), A(2), A(3a), A(3b), A(4), A(5), A(6a), and A(6b). Therefore, it is possible to specify corresponding component arrangement section A by identifying identification mark M.

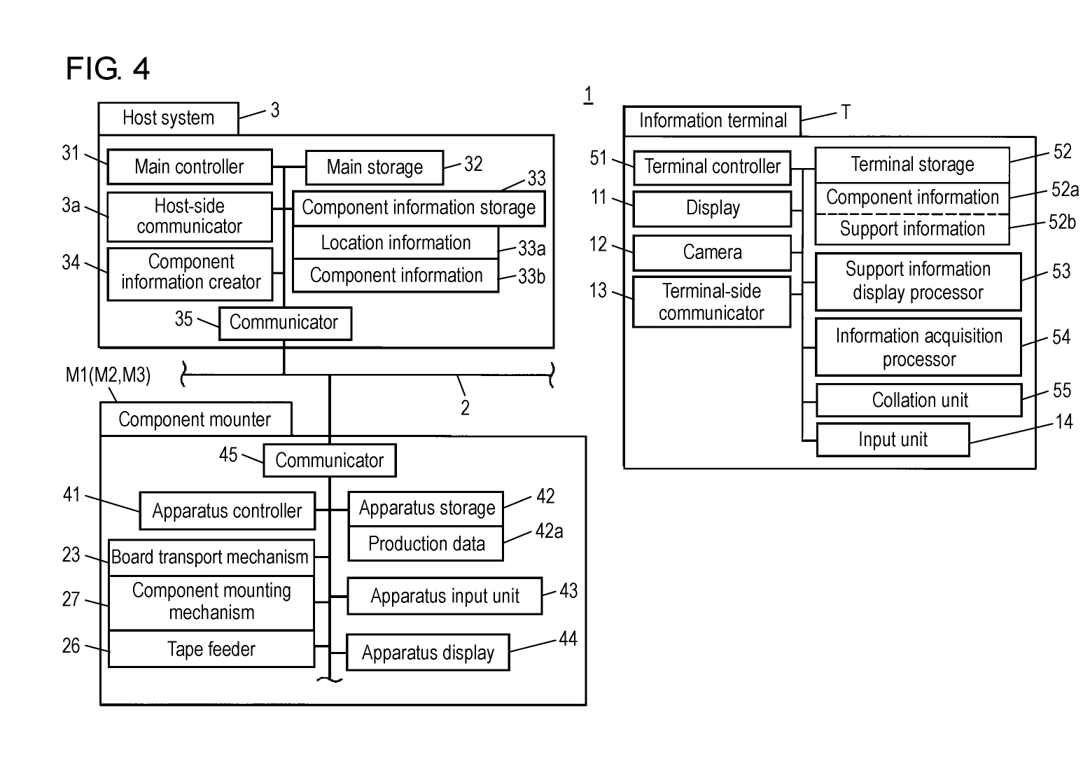

Next, a configuration of a control system of component mounting system 1 (component management support system) will be described with reference to FIG. 4. Host system 3 includes main controller 31 having a function as a management computer and main storage 32, component information storage 33, and component information creator 34, and performs receiving and transmitting of a control signal and data between devices configuring component mounting system 1 via communicator 35 and host-side communicator 3a. Component information storage 33 stores location information 33a, component information 33b, or the like.

In location information 33a, a location of component D used in component mounting system 1, or to be used from now on is stored in association with information of bar code B (identification mark) attached to reel C storing component D. Information specifying component mounters M1 to M3 on which tape feeder 26 supplying component D is mounted, component arrangement section A of component storage place S storing component D, a transport vehicle transporting component D, or the like as the location of component D is stored. As described above, component information storage 33 is a storage which stores the location of component D.

Component information creator 34 creates component information 33b including information specifying component arrangement section A of component D put-in and out to and from component storage place S based on production data including information of component D for each type of the board to be produced stored in main storage 32, or the like, and location information 33a. That is, component information 33b includes information of the component put-in and out to and from component arrangement section A of component storage place S. Created component information 33b is stored in component information storage 33 and a part of or an entirety thereof is transmitted to information terminal T according to a request from information terminal T.

In FIG. 4, component mounters M1 to M3 have the same configuration and component mounter M1 will be described here. Component mounter M1 includes apparatus controller 41, apparatus storage 42, apparatus input unit 43, and apparatus display 44, and is connected to communication network 2 via communicator 45. Apparatus controller 41 is a calculation processor and controls board transport mechanism 23, component mounting mechanism 27, and tape feeder 26 based on production data 42a stored in apparatus storage 42, that is, mounting data or feeder arrangement data stored for each type of the board to be produced. Therefore, component mounting work for mounting the component D picked up from each tape feeder 26 on board 21 is executed.

Apparatus input unit 43 is an input device such as a keyboard, a touch panel, or a mouse, and is used when inputting an operation command or data. Apparatus display 44 is a display such as a liquid crystal panel and displays various screens such as an operation screen for operation by apparatus input unit 43 and various types of information.

In FIG. 4, information terminal T includes terminal controller 51, terminal storage 52, support information display processor 53, information acquisition processor 54, collation unit 55, display 11, camera 12, terminal-side communicator 13, and input unit 14. Terminal controller 51 controls each unit of information terminal T based on a control program stored in terminal storage 52. Terminal storage 52 stores various types of information such as component information 52a and support information 52b in addition to the control program.

Information acquisition processor 54 specifies component arrangement section A based on a result of a recognition process of identification mark M attached to a predetermined position of component storage place S imaged by camera 12 (imaging unit), and acquires the component information (component information 33b) put-in and out to and from component arrangement section A based on imaged identification mark M. The acquired component information (component information 33b) is stored in terminal storage 52 as component information 52a.

Support information display processor 53 creates support information 52b for specifying component arrangement section A that is a storage destination of component D based on component information 52a (component information) acquired by information acquisition processor 54, and displays support information 52b on display 11 to be superimposed when component D is stored in component storage place S by a worker. Support information display processor 53 creates support information 52b for specifying component arrangement section A storing pick-up component D based on component information 52a (component information) acquired by information acquisition processor 54, and displays support information 52b on display 11 to be superimposed when component D is picked up from component storage place S by the worker. That is, support information 52b includes information for specifying component arrangement section A to and from which component D is put in and out in component storage place S.

Created support information 52b is stored in terminal storage 52. As described above, support information display processor 53 displays support information 52b for supporting put-in and out of component D to and from component storage place S on display 11 to be superimposed.

Collation unit 55 specifies component D based on bar code B (identification mark) corresponding to component D attached to reel C imaged by camera 12 (imaging unit) and collates whether or not specified component D is included in component information 52a (acquired component information). In support information display processor 53, a collation result of stored component D or picked-out component D by collation unit 55 is displayed on display 11 to be superimposed when component D is stored in component storage place S by the worker or when component D is picked up from component storage place S.

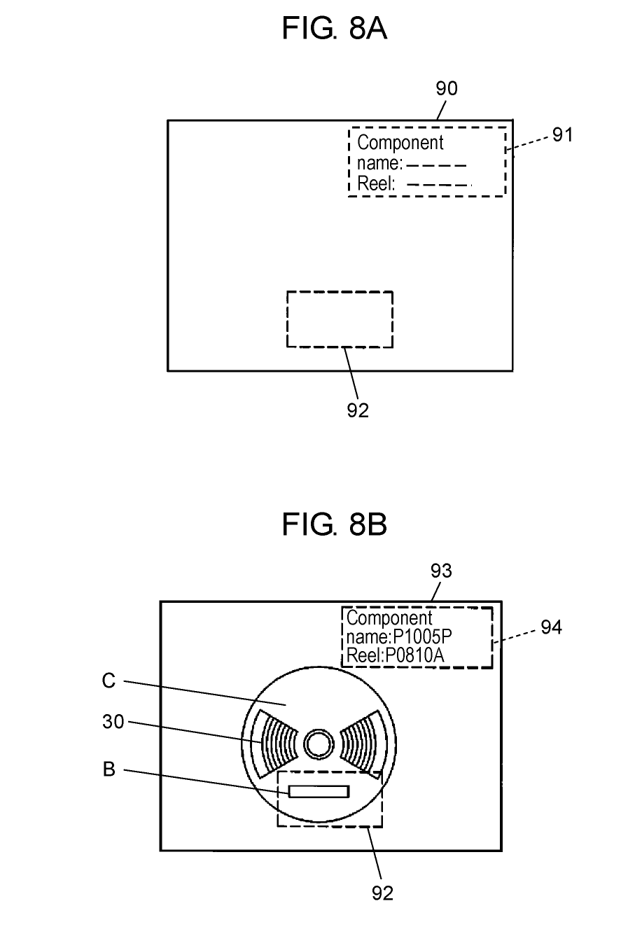

Collation unit 55 displays identification frame 92 (see FIG. 8A) that is a guide for positioning bar code B (identification mark) corresponding to component D to be collated on display 11 to be superimposed when bar code B is collated. Collation unit 55 transmits information of a fact of a case where the collation result of collated component D matches component information 52a (acquired component information) when component D is stored in component storage place S by the worker or when component D is picked up from component storage place S, to host system 3, and updates location information 33a (location of the component) stored in component information storage 33 (storage).

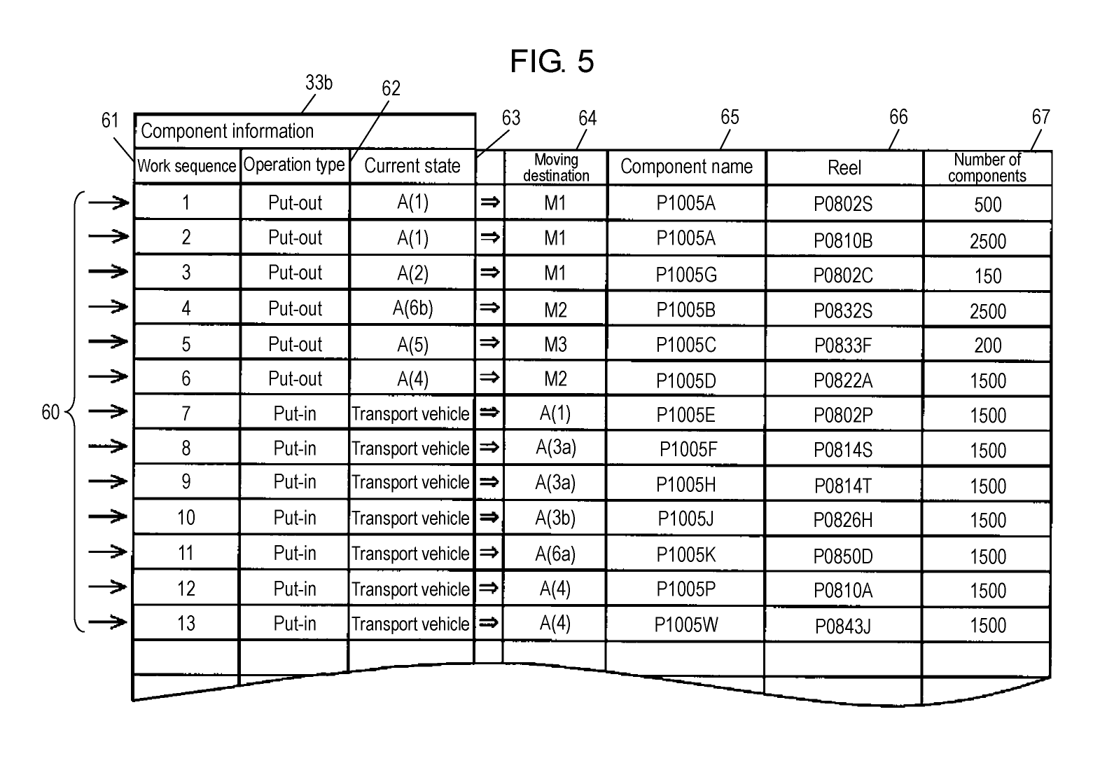

Next, a data configuration of component information 33b will be described with reference to FIG. 5. In FIG. 5, component information 33b is prepared every time the component put-in and out work for put-in and out of reel C storing component D to and from component storage place S, and unit work information 60 defining work contents to be executed for individual component D which is to be worked by the worker is displayed in the order of “work sequence” 61 to execute work. That is, unit work information 60 includes each item of “work sequence” 61, “operation type” 62, “current state” 63, “moving destination” 64, “component name” 65, “reel” 66, and “number of components” 67.

“Operation type” 62 is type information indicating the type of the execution operation performed in unit work information 60 in the component put-in and out work. In the embodiment, as operation information, “put-out” indicating a put-out operation for put-out component D from component storage place S and “put-in” indicating the storing operation for storing component D in component storage place S are defined.

“Current state” 63 indicates a position before the work execution of component D to be worked in the component put-in work and in the case of “put-out”, component arrangement section A of component storage place S in which component D is stored is indicated. “Moving destination” 64 indicates an arrangement destination of component D after the work execution, in a case of “put-out”, component mounters M1 to M3 of the moving destination are indicated and in a case of “put-in”, component arrangement section A of component storage place S in which component D is stored is indicated.

“Component name” 65 appended to each unit work information 60 indicates the component name of component D stored in reel C. “Reel” 66 indicates the number of identification recorded in bar code B (identification mark) attached to reel C. “Number of components” 67 indicates the number of components D stored in reel C.

In the example illustrated in FIG. 5, “work sequence” 61 is sorted in component arrangement section A of “operation type” 62, “current state” 63, or “moving destination” 64. Therefore, “work sequence” 61 is provided in which the operation such as “put-out” and “put-in” is the same unit work and the same unit work is close to component arrangement section A to be put-in and out. It is possible to efficiently execute the work by preventing work mistake of the worker by executing the component put-in and out work according to “work sequence” 61.

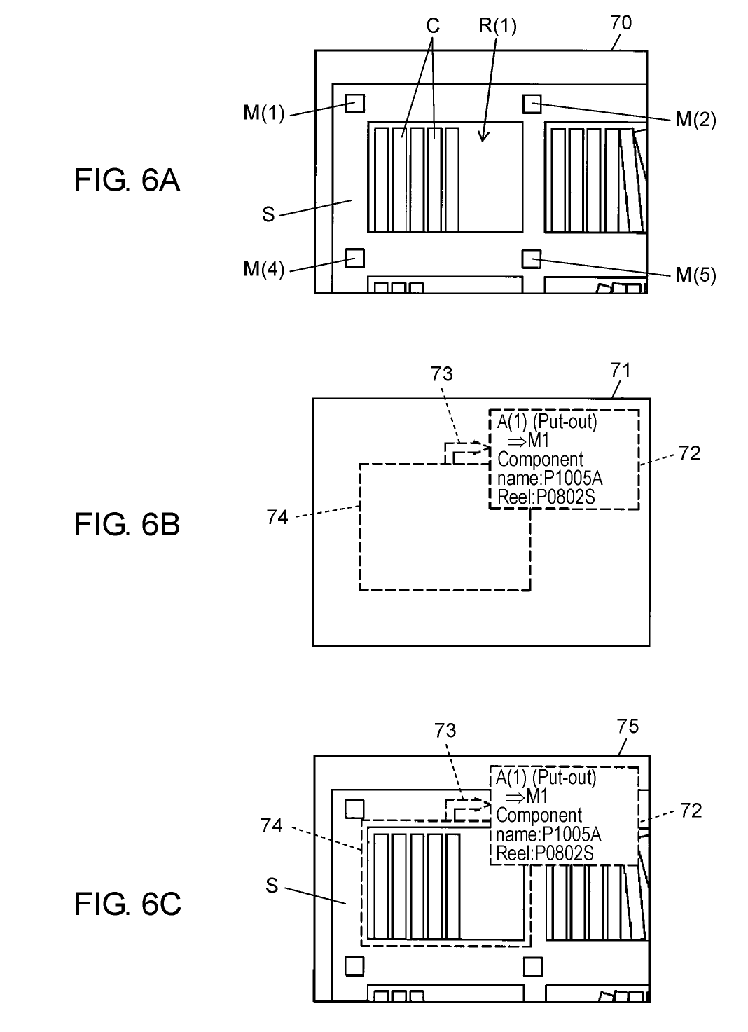

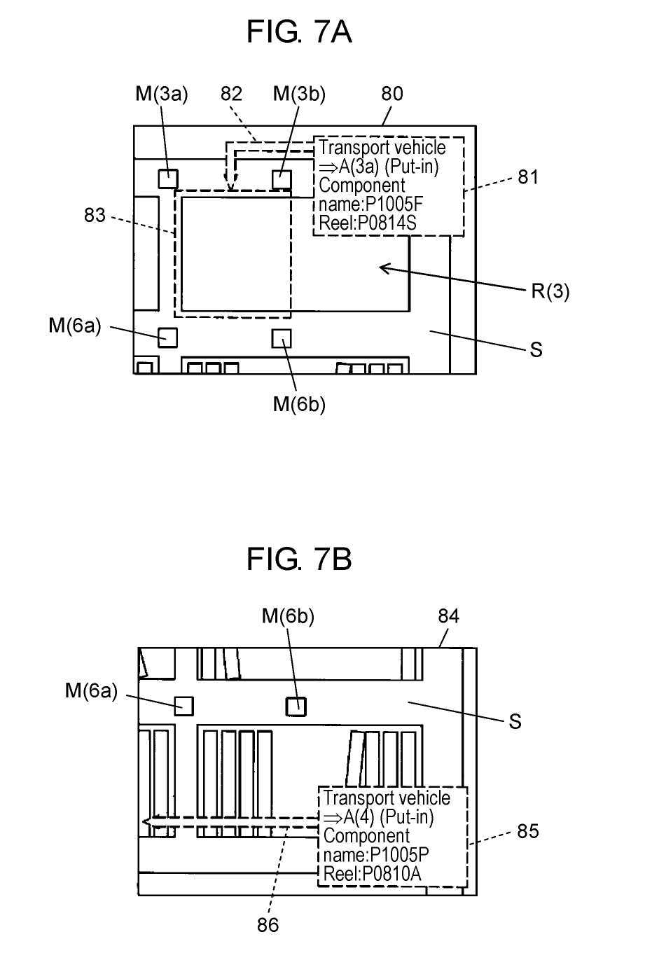

Next, support information 52b displayed on display 11 of information terminal T will be described with reference to FIGS. 6A to 7B. Hereinafter, an example, in which the unit work of component information 33b illustrated in FIG. 5 is executed in the order of “work sequence” 61, will be described. FIG. 6A illustrates an example of image 70 outside information terminal T visible to the worker through a half mirror of display 11 when the worker wearing information terminal T watches the vicinity of shelf R(1) (component arrangement section A(1)) of component storage place S in which reel C storing component D to be worked is stored in executing the unit work in which “work sequence” 61 is “1”. A similar image is also imaged by camera 12 of information terminal T and identification marks M(1), M(2), M(4), and M(5) which are images of camera 12 are recognized by information acquisition processor 54.

FIG. 6B illustrates an example of image 71 projected on display 11 by support information display processor 53 to be superimposed on the field of view of the worker. Here, support information 52b (unit work information 60) in which “work sequence” 61 of component information 33b illustrated in FIG. 5 is “1 is displayed. In image 71, support information 52b includes text information 72 including information of “operation type” 62, “current state” 63, “moving destination” 64, “component name” 65, and “reel” 66, arrow 73 visually indicating the information (here, “put-out”) of “operation type” 62, and position information 74 visually indicating the position of component arrangement section A(1) as the unit work target. In text information 72, information of a plurality of components D to be worked by same component arrangement section A(1) may be displayed in a table.

FIG. 6C illustrates an example of image 75 displayed on display 11 which is visibly recognized by the worker wearing information terminal T, and image 71 projected by support information display processor 53 illustrated in FIG. 6B is to be superimposed on outside image 70 watched through the half mirror illustrated in FIG. 6A. As described above, in display 11, support information 52b for supporting the put-out operation for put-out component D from component storage place S is displayed to be superimposed on the field of view of the worker wearing information terminal T. Support information display processor 53 can display support information 52b such as position information 74 at a predetermined position of image 70 further correctly to be superimposed by identifying close identification marks M(2), M(4), and M(5) simultaneously in addition to identification mark M(1) indicating component arrangement section A(1) as the unit work target.

FIG. 7A illustrates an example of image 80 in which support information 52b (unit work information 60) in which “work sequence” 61 of component information 33b illustrated in FIG. 5 is “8” is displayed to be superimposed on display 11. Here, the information of “operation type” 62 is “put-in” and in addition to text information 81, arrow 82 visually indicating information (here, “put-in”) of “operation type” 62, and position information 83 visually indicating the position of component arrangement section A(3a) set in shelf R(3) as the unit work target are displayed to be superimposed.

FIG. 7B illustrates an example of image 84 in which support information 52b (unit work information 60) in which “work sequence” 61 of component information 33b illustrated in FIG. 5 is “12” is displayed to be superimposed on display 11. Here, the information of “operation type” 62 is “put-in” and text information 85 is displayed to be superimposed. In FIG. 7B, component arrangement section A(4) as the unit work target is not included in image 84 and arrow 86 visually indicating a direction in which component arrangement section A(4) is present is displayed to be superimposed.

As described above, support information display processor 53 displays support information 52b for supporting put-in and out of component D to and from component storage place S on display 11 to be superimposed on the field of view of the worker based on information imaged by camera 12 (imaging unit). Therefore, the worker can intuitively grasp the position (component arrangement section A) to and from which component D is put in and out in shelf R of component storage place S and can execute efficiently the component put-in and out work.

Next, support information 52b displayed on display 11 of information terminal T when bar code B (identification mark) attached to reel C in which component D is stored is collated will be described with reference to FIGS. 8A and 8B. FIG. 8A illustrates an example of image 90 which is reflected on display 11 by support information display processor 53 during the collation and is superimposed on the field of view of the worker. Text information 91 including information of “component name” 65 and “reel” 66 included in collated bar code B, and identification frame 92 that is a guide for positioning bar code B are included in image 90. In FIG. 8A, since there is no bar code B in identification frame 92, “component name” 65 and “reel” 66 are not displayed on text information 91.

FIG. 8B illustrates an example of image 93 which is displayed on display 11 which is visibly recognized by the worker wearing information terminal T when collating bar code B attached to reel C to be worked in which “work sequence” 61 of component information 33b illustrated in FIG. 5 is 12. Carrier tape 30 storing component D is wound and stored in reel C. When the worker adjusts the orientation of the face and inserts bar code B in identification frame 92, bar code B is collated by collation unit 55 and the collation result of collated component D is displayed in text information 94. As described above, it is possible to easily execute the collation in bar code B by displaying identification frame 92 positioning bar code B (identification mark) in the field of view of the worker.

As described above, component mounting system 1 of the embodiment includes camera 12 (imaging unit), display 11 which displays support information 52b to be superimposed on the field of view of the worker based on the information imaged by camera 12, and support information display processor 53 which displays support information 52b to be superimposed on display 11. Component mounting system 1 configures the component management support system for supporting the put-in and out of component D to and from component storage place S by the worker. Therefore, the worker can intuitively grasp the position (component arrangement section A) to and from which component D is put in and out in shelf R of component storage place S and can execute efficiently the component put-in and out work.

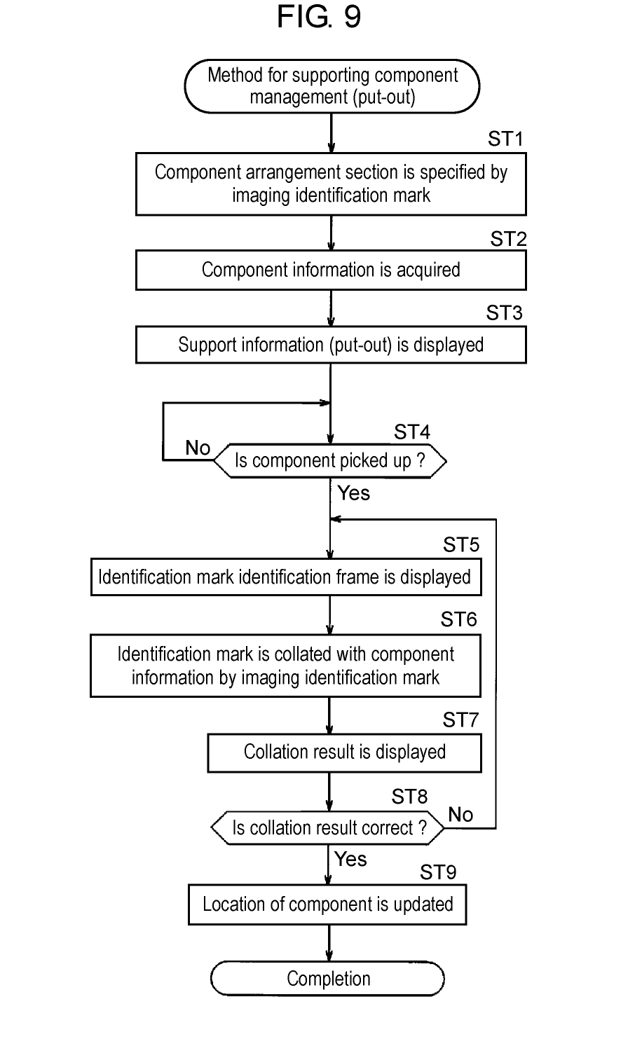

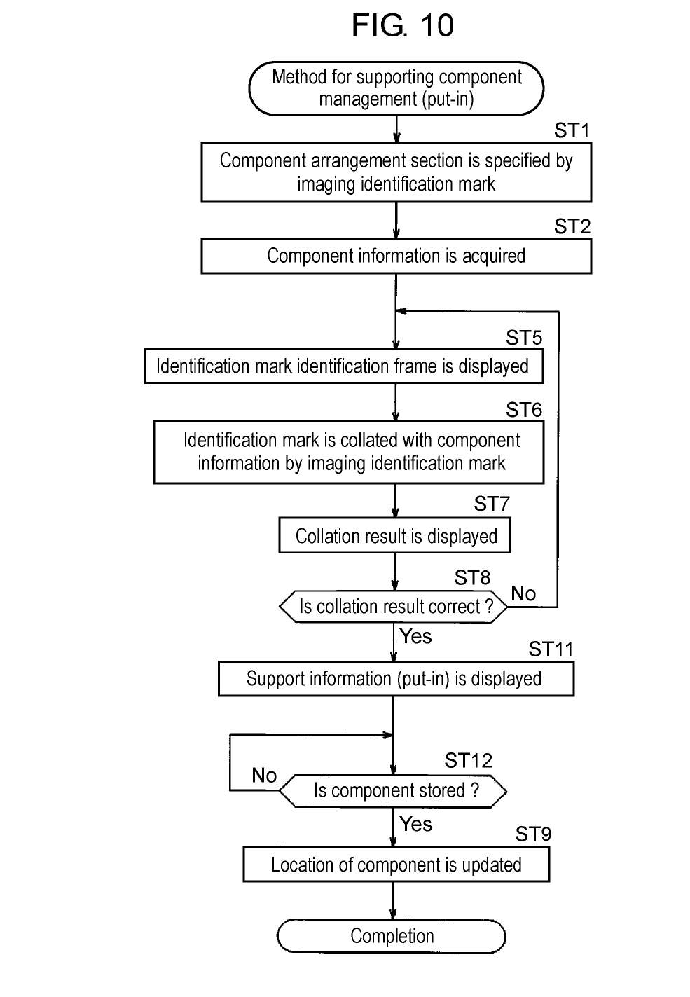

Next, a method for supporting component management for supporting put-in and out of component D to and from component storage place S by the worker in component mounting system 1 (component management support system) will be described with reference to FIGS. 9 and 10. First, a pick-up operation (put-out) for picking up component D from component storage place S will be described with reference to FIG. 9. During the pick-up operation, the worker pushes the transport vehicle on which picked-up reel C is placed and moves the transport vehicle to the front of component storage place S to be worked. When the worker wearing information terminal T faces the direction of shelf R of component storage place S which is recognized to be worked, identification mark M attached to component storage place S is imaged by camera 12.

When identification mark M is imaged, information acquisition processor 54 recognizes identification mark M and specifies component arrangement section A (ST1: recognizing step). That is, component arrangement section A is specified based on identification mark M attached to a predetermined position of component storage place S to be imaged. Next, information acquisition processor 54 acquires the information (component information 33b) of the component put-in and out to and from component arrangement section A by host system 3 based on imaged identification mark M (ST2: component information acquiring step). Acquired component information 33b is stored in terminal storage 52 as component information 52a.

Next, support information display processor 53 creates support information 52b for specifying shelf R (component arrangement section A) storing component D which is picked up based on component information 52a and displays support information 52b on display 11 to be superimposed (ST3: put-out support information displaying step) (for example, see FIG. 6C). That is, support information 52b for specifying component arrangement section A storing picked-up component D is displayed on display 11 to be superimposed based on component information 52a (component information) acquired when component D is picked up from component storage place S.

In FIG. 9, instructed reel C (component D) is picked up from component arrangement section A (shelf R) by the worker. Collation unit 55 waits until the pick-up of component D is completed by the worker (No in ST4). In this state, when the worker inputs the completion of the pick-up work into input unit 14 of information terminal T, collation unit 55 determines that the pick-up work is completed (Yes in ST4) and collation unit 55 displays identification frame 92, which is a guide for positioning bar code B (identification mark) corresponding to component D to be collated, on display 11 to be superimposed (ST5: identification frame displaying step) (for example, see FIG. 8A).

Next, the worker positions bar code B attached to reel C in identification frame 92. Collation unit 55 recognizes bar code B imaged by camera 12 and specifies component D (for example, see FIG. 8B), and collates component D with component information 52a (ST6: identifying step). That is, component D is specified and is collated with acquired component information 52a (component information) based on bar code B (identification mark) corresponding to imaged component D.

Next, support information display processor 53 displays the collation result on display 11 to be superimposed (ST7: collation result displaying step). That is, the collation result of pick-up component D is displayed on display 11 to be superimposed when component D is picked up from component storage place S. Next, collation unit 55 determines whether or not the collation result matches component information 52a, that is, it is reel C storing component D indicated by support information 52b (ST8: collation determining step). If the collation result does not match (No in ST8), the worker returns reel C to original shelf R and returns to the identification frame displaying step (ST5), and performs the collation of another component D which is picked up from shelf R.

If the collation result matches (Yes in ST8), collation unit 55 updates location information 33a by communicating with host system 3 (ST9: location updating step). That is, when component D is picked up from component storage place S, if the collation result of collated component D matches acquired component information 52a (component information), stored location information 33a (location of the component) is updated. Therefore, it is possible to easily manage the location of component D. In the collation determining step (ST8), even in a case where the collated component is not component D indicated by support information 52b, in a case where the collated component matches component D to be picked up later after being included in component information 52a, it may be determined that the collation result matches.

Next, the storing operation (put-in) for storing component D in component storage place S will be described with reference to FIG. 10. Hereinafter, the same reference numerals are given to the same steps in the pick-up operation described above and detailed description will be omitted. During the storing operation, the worker pushes the transport vehicle on which storing reel C is placed and moves the transport vehicle to the front of component storage place S to be worked. When the worker wearing information terminal T faces the direction of shelf R of component storage place S which is recognized to be worked, an identifying step (ST1) and a component information acquiring step (ST2) are executed.

Next, the worker determines whether or not the component is a predetermined component D by collecting bar code B attached to reel C to be stored. That is, an identification frame displaying step (ST5), an identifying step (ST6), and a collation result displaying step (ST7) are executed. That is, the collation result of stored component D is displayed on display 11 to be superimposed when a component is stored in component storage place S. Next, a collation determining step (ST8) is executed. In the collation determining step (ST8), when the collation result matches (Yes), support information display processor 53 creates support information 52b for specifying component arrangement section A storing component D based on component information 52a and displays support information 52b on display 11 to be superimposed (ST11: put-in support information displaying step) (for example, see FIG. 7A).

That is, when component D is stored in component storage place S, support information 52b for specifying component arrangement section A that is the storage destination of component D is displayed on display 11 to be superimposed based on acquired component information 52a (component information). Next, the worker stores reel C (component D) in instructed component arrangement section A (shelf R). Collation unit 55 waits until the storage of component D is completed by the worker (No in ST12).

In this state, when the worker inputs the completion of the storage work into input unit 14 of information terminal T, collation unit 55 determines that the storage work is completed (Yes in ST12) and a location updating step (ST9) is executed. That is, when component D is stored in component storage place S, in a case where the collation result of collated component D matches acquired component information 52a (component information), stored location information 33a (location of the component) is updated. Therefore, it is possible to easily manage the location of component D.

As described above, the method for supporting component management of the embodiment includes preparing support information 52b for supporting the put-in and out of the component D to and from the component storage place S, and displaying support information 52b for supporting put-in and out of component D to and from component storage place S on display 11 of information terminal T mounted on the worker to be superimposed on the field of view of the worker. Therefore, the worker can intuitively grasp the position (component arrangement section A) to and from which component D is put in and out in component storage place S and can execute efficiently the component put-in and out work.

The order of the pick-up operation and the storing operation (component put-in and out work) in the method for supporting component management may be configured such that the storing operation (put-in) may be started after all pick-up operations (put-out) are completed as in the “work sequence” 61 of component information 33b illustrated in FIG. 5, but the order is not limited thereto. For example, after the component put-in and out operations are completed in same shelf R (component arrangement section A), the component put-in and out work may be executed in next shelf R (for example, “work sequence” 61 in FIG. 5 is the order of “1”, “2”, “7”, “3”.). In the storing operation, the worker collates bar code B with the order of the pick-up of component D to be stored from the transport vehicle and may store component D in shelf R instructed by support information 52b.

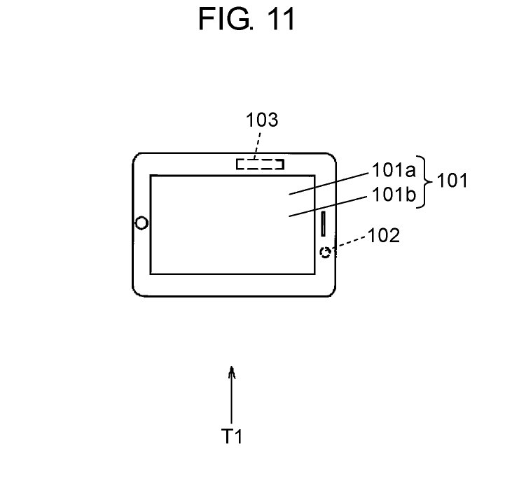

Next, a second example of information terminal T used in component mounting system 1 (component management support system) of the embodiment will be described with reference to FIG. 11. Information terminal T1 of the second example is a smart phone, a tablet PC, or the like, and includes touch panel 101, camera 102, and terminal-side communicator 103. Touch panel 101 has a function of combining display 101a such as a liquid crystal panel or an organic EL panel, and input unit 101b such as a touch pad, displaying the image of camera 102 or various types of information, and inputting an operation command or various types of data. Camera 102 is an imaging unit for capturing a moving image or a still image.

A lens of camera 102 is provided so as to be opened on the opposite side to touch panel 101 and when camera 102 is directed to a desired direction to be imaged, the captured image is displayed on touch panel 101. In information terminal T1 of the second example, when component storage place S to be worked is imaged by camera 102 in the component put-in and out work, the display on touch panel 101 (display 101a) is different from information terminal T of the first example.

That is, in display 101a of information terminal T1 of the second example, when identification mark M attached to component storage place S is imaged by camera 102, support information 52b for supporting put-in and out of component D to and from component storage place S is displayed on an image obtained by imaging component storage place S to be superimposed based on information imaged by camera 102 (imaging unit) by support information display processor 53.

That is, in information terminal T1 of the second example, image 70 outside information terminal T illustrated in FIG. 6A is the image captured by camera 102, support information 52b similar to that of FIG. 6B is superimposed, and the display similar to that of FIG. 6C is displayed on touch panel 101 (display 101a). Therefore, the worker can intuitively grasp the position (component arrangement section A) to and from which component D is put in and out in component storage place S.

In information terminal T1 of the second example, when identification mark M attached to component storage place S is identified, the image of component storage place S is recorded as a still image, and the same support information 52b as that of FIG. 6B may be displayed to be superimposed on the still image (image obtained by imaging component storage place 5). Therefore, the worker places information terminal T1 of the second example displaying the still image on the transportation vehicle and can execute an operation such as pick-up or storing operation of reel C (component D) with both empty hands while referring support information 52b displayed to be superimposed on the still image displayed on touch panel 101 (display 101a).

### CONCLUSION

As described above, component mounting system 1 (the component management support system) in the embodiment is component mounting system 1 supporting put-in and out of component D to and from component storage place S. Component mounting system 1 includes camera (imaging unit) that images information, support information display processor 53 that generates a superimposed composite image by superimposing support information 52b for supporting the put-in and out of component D to and from component storage place S on the image obtained by imaging component storage place S or the field of view of the worker, and the display that displays the superimposed composite image.

The method for supporting component management in the embodiment is a method for supporting component management supporting the put-in and out of component D to and from the component storage place. The method for supporting component management includes preparing support information 52b for supporting the put-in and out of the component D to and from the component storage place S, generating a superimposed composite image by superimposing support information 52b on the image obtained by imaging component storage place S or on the field of view of the worker, and displaying the superimposed composite image on the display.

The component management support system and the method for supporting component management of the disclosure have an effect that the worker can intuitively grasp the position to and from which the component is put in and out, and are useful in a component mounting field where components are mounted on a board.

What is claimed is:

1. A component management support system which supports put-in and out of a component to and from a component storage placer, the system comprising:
an imaging unit that images information;
a support information display processor that generates a superimposed composite image by superimposing support information for supporting the put-in and out of the component to and from the component storage place on an image obtained by imaging the component storage place or a field of view of the worker; and
a display that displays the superimposed composite image.

2. The component management support system of claim 1,
wherein the support information includes information for specifying a component arrangement section to and from which the component is put in and out in the component storage place.

3. The component management support system of claim 2,
wherein the imaging unit images an identification mark attached to a predetermined position of the component storage place; and
the component management support system further comprising an information acquisition processor which specifies the component arrangement section based on the identification mark imaged by the imaging unit.

4. The component management support system of claim 3,
wherein the information acquisition processor acquires information of the component put-in and out to and from the component arrangement section, based on the imaged identification mark.

5. The component management support system of claim 4,
wherein, when the component is stored in the component storage place, the support information display processor displays the support information for specifying the component arrangement section that is a storage destination of the component based on information of the component acquired by the information acquisition processor, on the display to be superimposed.

6. The component management support system of claim 4,
wherein, when the component is picked up from the component storage place, the support information display processor displays the support information for specifying the component arrangement section that stores the component to be picked up based on information of the component acquired by the information acquisition processor, on the display to be superimposed.

7. The component management support system of claim 5, further comprising:
a collation unit which specifies the component based on an identification mark corresponding to the component imaged by the imaging unit and collates the component with the acquired information of the component,
wherein, when the component is stored in the component storage place or when the component is picked up from the component storage place, the support information display processor displays a collation result of the component to be stored or the component to be picked up by the collation unit, on the display to be superimposed.

8. The component management support system of claim 7,
wherein the collation unit displays a frame which is a guide for positioning the identification mark corresponding to the component to be collated, on the display to be superimposed.

9. The component management support system of claim 7, further comprising:
a storage which stores a location of the component,
wherein, when the component is stored in the component storage place or when the component is picked up from the component storage place, the collation unit updates the location of the component stored in the storage in a case where the collation result of the collated component matches the acquired information of the component.

10. A method for supporting component management for supporting put-in and out of a component to and from a component storage place, the method comprising:
preparing support information for supporting the put-in and out of the component to and from the component storage place;
generating a superimposed composite image by superimposing the support information on an image obtained by imaging the component storage place or a field of view of the worker; and
displaying the superimposed composite image on a display.

11. The method for supporting component management of claim 10,
wherein the support information includes information for specifying a component arrangement section to and from which the component is put in and out in the component storage place.

12. The method for supporting component management of claim 11, further comprising;
imaging an identification mark attached to a predetermined position of the component storage place; and
specifying the component arrangement section based on the imaged identification mark.

13. The method for supporting component management of claim 12, further comprising;
Acquiring information of the component put-in and out to and from the component arrangement section based on the imaged identification mark.

14. The method for supporting component management of claim 13,
wherein, when the component is stored in the component storage place, the support information for specifying the component arrangement section that is a storage destination of the component is displayed on the display to be superimposed based on the acquired information of the component.

15. The method for supporting component management of claim 13,
wherein, when the component is picked up from the component storage place, the support information for specifying the component arrangement section that stores the component to be picked up is displayed on the display to be superimposed based on the acquired information of the component.

16. The method for supporting component management of claim 14,
wherein the component is specified based on an identification mark corresponding to the component to be imaged and the specified component is collated with the acquired information of the component, and
wherein, when the component is stored in the component storage place or when the component is picked up from the component storage place, a collation result of the component to be stored or the component to be picked up is displayed on a display to be superimposed.

17. The method for supporting component management of claim 16,
wherein, when the component is collated, a frame which is a guide for positioning an identification mark corresponding to the component to be collated is displayed on the display to be superimposed.

18. The method for supporting component management of claim 16,
wherein, when the component is stored in the component storage place or when the component is picked up from the component storage place, a location of the stored component is updated in a case where the collated collation result of the component matches the acquired information of the component.
